(19) United States
(12) Patent Application Publication
(10) Pub. No.: US 2026/0235211 A1
(43) Pub. Date: Aug. 13, 2026

(54) DUSTPROOF GATE VALVE

(71) Applicant: KING LAI HYGIENIC MATERIALS CO., LTD., Taichung City (TW)

(72) Inventor: CHENG-CHI LIN, Taichung City (TW)

(73) Assignee: KING LAI HYGIENIC MATERIALS CO., LTD., Taichung City (TW)

(21) Appl. No.: 19/407,721

(22) Filed: Dec. 3, 2025

(30) Foreign Application Priority Data
Feb. 12, 2025 (TW) 114105236

(51) Int. Cl. F16K 3/20; F16K 3/02

(52) U.S. Cl. CPC F16K 3/20; F16K 3/0227; F16K 3/0254

(57) ABSTRACT

A dustproof gate valve includes: a housing having a first plate and a second plate; two swing arms having ends respectively disposed on opposite sides of a movable ring, with a sealing ring disposed on the movable ring and a plurality of elastic members disposed between the movable ring and the second plate; a sliding valve plate having a plate body and two roller assemblies, the roller assemblies each including an arm roller such that the arm rollers roll against the respective swing arms; and an actuator. Each of the two swing arms has a pressing edge, a closing positioning groove and an opening positioning groove recessed from the pressing edge such that the arm rollers roll against or into the grooves. When the arm rollers roll into the opening positioning groove, the movable ring is pressed against the first plate such that the sealing ring engages the first plate to provide sealing.

The most illustrative figure of the disclosure: FIG. 8

The legend of the most illustrative figure is as follows:

13: first flange
17: second flange
21: swing arm
211: pressing edge
22: closing positioning groove
24: opening positioning groove
25: movable ring
32: plate body
34: roller assembly
341: plate roller
342: arm roller
41: actuator
LEGEND
10: dustproof gate valve
11: housing
12: first plate
121: first valve opening
13: first flange
16: second plate
17: second flange
19: receiving space
191: sidewall
21: swing arm
211: pressing edge
22: closing positioning groove
24: opening positioning groove
25: movable ring
251: second valve opening
26: contacting surface
261: sealing ring
27: elastic member
31: sliding valve plate
32: plate body
321: arc-shaped recess
323: driving slot
34: roller assembly
341: plate roller
342: arm roller
343: side roller
41: actuator
42: knob
44: linkage arm
441: slider
S: spacing
121′: first valve opening
13′: first flange
17′: second flange
251′: second valve opening
10″: dustproof gate valve
12″: first plate
121″: first valve opening
122″: docking surface
25″: movable ring
261″: sealing ring

### BACKGROUND OF THE INVENTION

### 1. Technical Field

The present disclosure relates to gate valves, and more particularly to a dustproof gate valve.

### 2. Description of Related Art

Taiwan Patent No. I551798, corresponding to U.S. Pat. No. 9,464,721, discloses a gate valve with a locking function. As disclosed in that disclosure, an actuator drives a swing arm, which in turn drives a sliding seat to move. When the swing arm is moved to a second locking position, the valve element on the sliding seat closes its valve opening, thereby achieving an effect of simultaneously locking the valve element when closed.

However, when the foregoing technique of that disclosure is applied to a contaminated environment, for example, in an environment with substantial dust, the valve element moves away from the valve opening and the valve opening communicates with the internal space of the gate valve as soon as the valve is open, even though the valve is capable of achieving sealing to block dust when closed. As a result, dust can easily enter the interior of the gate valve through the valve opening and contaminate the internal components of the gate valve.

Taiwan Patent No. I716250, corresponding to U.S. Pat. No. 11,112,012B2, discloses a gate valve with a dustproof function. That disclosure uses a dustproof tube (reference number 41) to cover a gap between the valve opening and the housing of the gate valve when open, thereby effectively preventing dust from entering the interior of the gate valve.

However, although the foregoing invention is prior art filed by the applicant of the present invention, its structural features still have room for simplification. For example, the dustproof effect could be achieved without the use of a dustproof tube. In addition, different operational states may result from such structural simplification. Accordingly, there remains a need for an improved gate valve structure capable of achieving dustproof performance with a simplified design, which is the problem addressed by the present invention.

### BRIEF SUMMARY OF THE INVENTION

It is an objective of the disclosure to provide a dustproof gate valve capable of maintaining a dustproof effect in an open state without using a dustproof tube.

To achieve the above and other objectives, the disclosure provides a dustproof gate valve, comprising: a housing having a first plate and a second plate, the housing defining therein a receiving space disposed between the first plate and the second plate, the first plate having a first valve opening penetrating therethrough; two swing arms disposed parallel to each other such that adjacent ends thereof are pivotally mounted inside the housing and remaining portions of the two swing arms are located in the receiving space, with other ends respectively disposed on opposite sides of a movable ring, the movable ring defining a second valve opening and being movably mounted on the second plate so as to move toward or away from the first plate, allowing the first valve opening and the second valve opening to face each other, the movable ring being in an airtight engagement with the second plate, wherein a portion of the movable ring faces the first plate and has a contacting surface on which a sealing ring is disposed, and a plurality of elastic members are disposed between the movable ring and the second plate such that the movable ring is urged toward the first plate by an elastic restoring force of the elastic members; a sliding valve plate having a plate body and two roller assemblies respectively disposed on opposite sides of the plate body and configured to move in unison with the plate body, each of the two roller assemblies comprising a plurality of plate rollers configured to roll against the first plate and comprising an arm roller, the two arm rollers being configured to roll against the respective swing arms; and an actuator disposed on one of the first plate and the second plate, connected to the sliding valve plate, and configured to drive the sliding valve plate to move within the receiving space so as to cause the roller assemblies to move relative to the swing arms, wherein each of the swing arms has a pressing edge, a closing positioning groove and an opening positioning groove recessed from the pressing edge such that the arm rollers of the roller assemblies roll against or into the grooves, with the closing positioning groove located between the opening positioning groove and the movable ring, wherein, when the arm rollers roll into the opening positioning groove, the plate body is not positioned between the movable ring and the first plate, and the plurality of elastic members maintain the movable ring pressed against the first plate such that the sealing ring engages the first plate to provide sealing, thereby allowing the first valve opening and the second valve opening to communicate with each other to allow passage of gas, while preventing gas from entering the receiving space due to the sealing engagement of the sealing ring, wherein, when the arm rollers roll against the pressing edge without rolling into the opening positioning groove or the closing positioning groove, the arm rollers press against the two swing arms to cause the swing arms to pivot, thereby forcing the movable ring to move away from the first plate against the elastic force of the plurality of elastic members so as to form a spacing between the movable ring and the first plate, allowing the plate body to enter, wherein, when the arm rollers roll into the closing positioning groove, the plate body enters between the movable ring and the first plate and fully covers the first valve opening, and the plurality of elastic members maintain the movable ring pressed against the plate body such that the sealing ring engages the plate body to provide sealing, thereby allowing the plate body to block communication between the first valve opening and the second valve opening and preventing gas from passing therethrough or entering the receiving space through the second valve opening due to the sealing engagement of the sealing ring.

Therefore, the disclosure provides an airtight seal by means of the sealing ring engaging the first plate to not only effectively prevent dust ingress but also eliminate the need for a dustproof tube and still maintain dustproof performance when a valve opening is in the open state, thereby achieving the aforementioned objectives of the disclosure.

### BRIEF DESCRIPTION OF THE SEVERAL VIEWS OF THE DRAWINGS

FIG. 1 is a perspective view of a first preferred embodiment of the disclosure.

FIG. 2 is a partially cut-away perspective view of a first preferred embodiment of the disclosure.

FIG. 3 is a top plan view showing the internal structure of the first preferred embodiment, with the housing removed.

FIG. 4 is a partially cut-away view of FIG. 3, mainly showing the arc-shaped recess of the plate body.

FIG. 5 is a cross-sectional view taken along line 5-5 of FIG. 3.

FIG. 6 is a cross-sectional view taken along line 6-6 of FIG. 3.

FIG. 7 is an enlarged partial view of FIG. 6.

FIG. 8 is a schematic operational view of the first preferred embodiment of the disclosure, viewed from an angle similar to FIG. 5.

FIG. 9 is an enlarged partial view of FIG. 8.

FIG. 10 is another schematic operational view of the first preferred embodiment of the disclosure, viewed from an angle similar to FIG. 5.

FIG. 11 is an enlarged partial view of FIG. 10.

FIG. 12 is a perspective view showing another aspect of a first preferred embodiment of the disclosure.

FIG. 13 is a perspective view of a second preferred embodiment of the disclosure.

FIG. 14 is a cross-sectional view taken along line 14-14 of FIG. 13.

### DETAILED DESCRIPTION OF THE INVENTION

Technical features of the disclosure are herein illustrated with preferred embodiments, depicted with drawings, and described below.

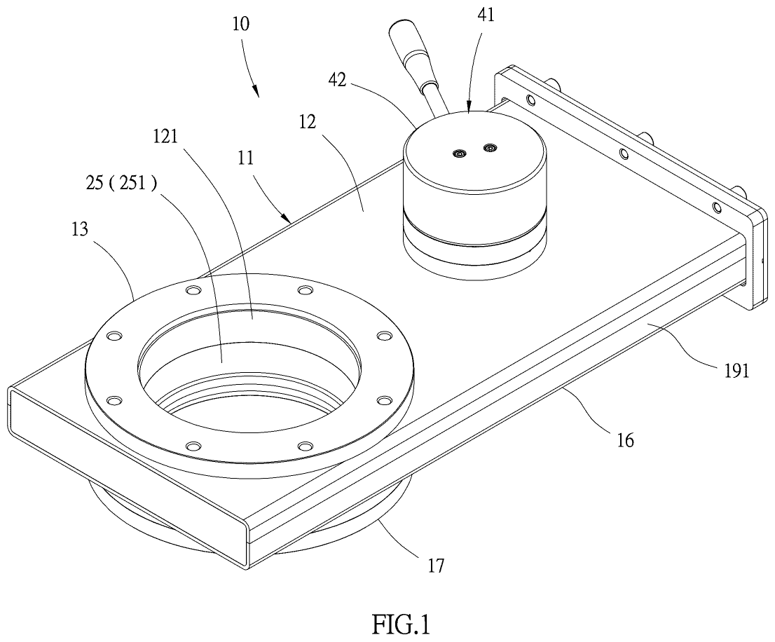

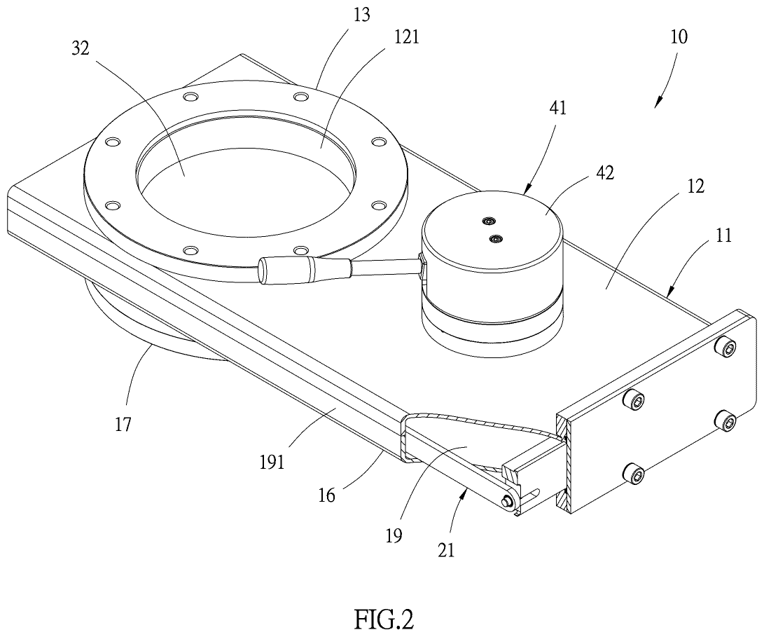

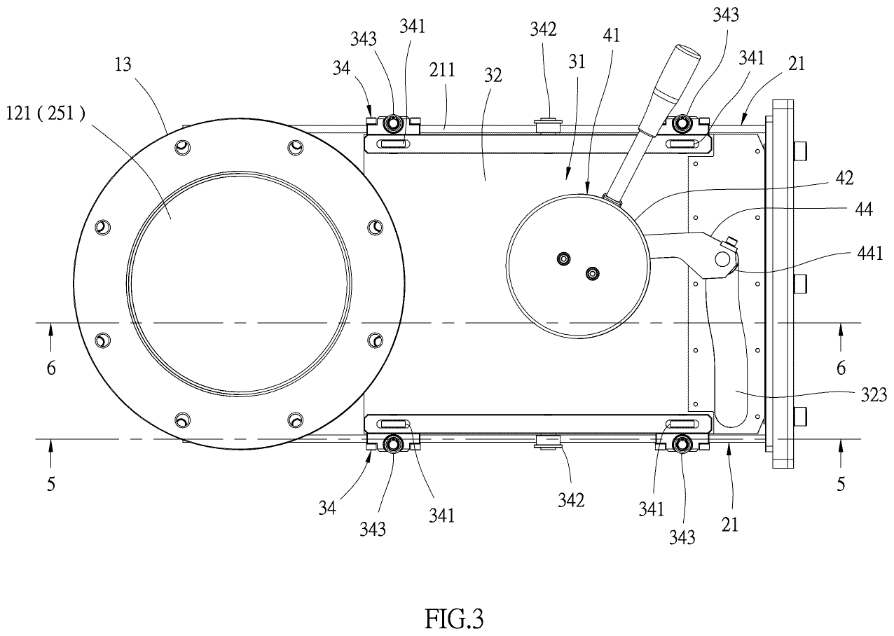

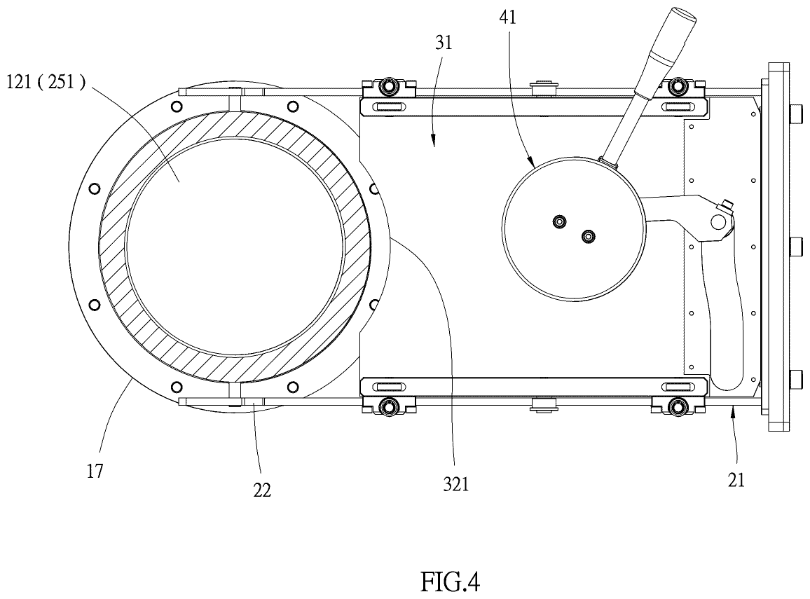

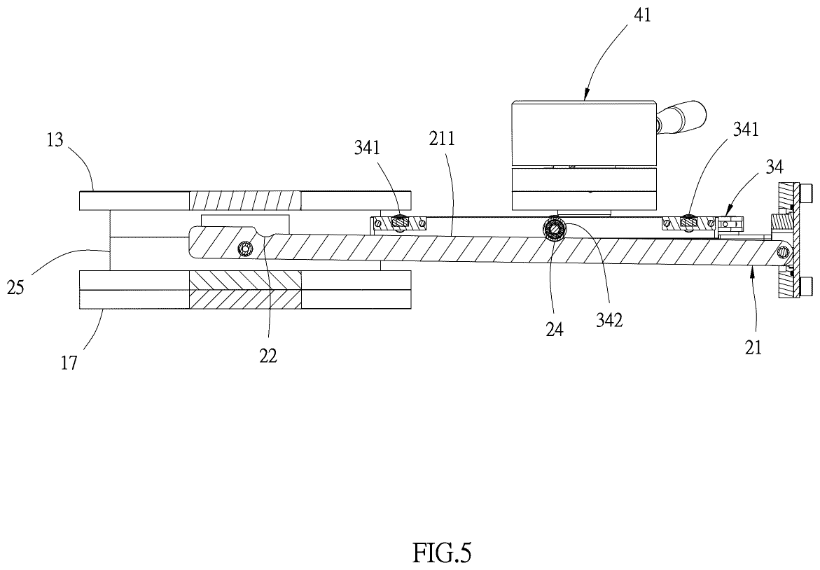

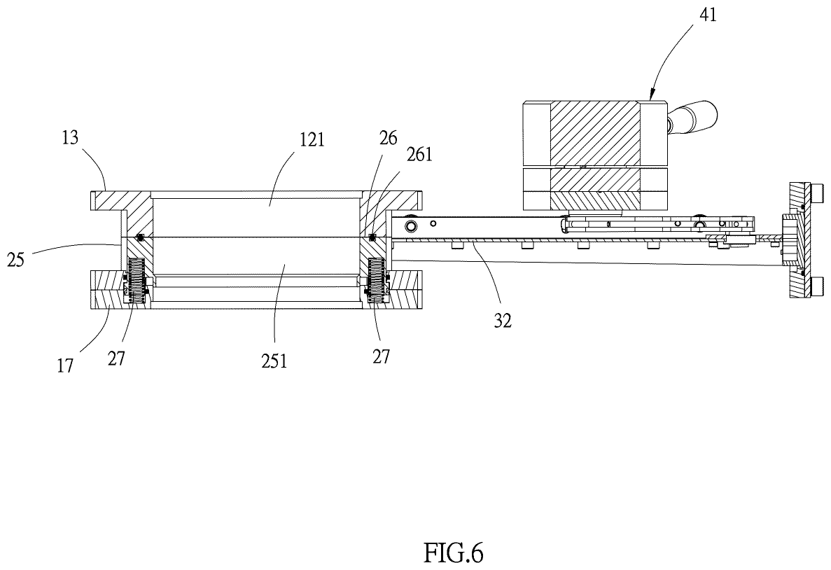

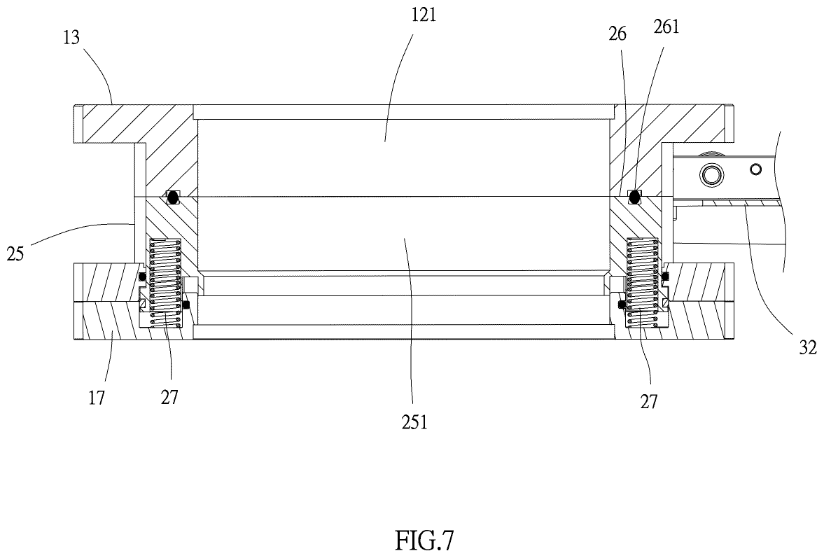

As shown in FIG. 1 through FIG. 7, the first preferred embodiment of the disclosure provides a dustproof gate valve 10 essentially comprising a housing 11, two swing arms 21, a sliding valve plate 31, and an actuator 41.

The housing 11 has a first plate 12 and a second plate 16. The housing 11 defines therein a receiving space 19 disposed between the first plate 12 and the second plate 16. The first plate 12 has a first valve opening 121 penetrating therethrough. In the first embodiment, the first plate 12 has a first flange 13, in which the first valve opening 121 is formed, and the second plate 16 has a second flange 17.

The two swing arms 21 are disposed parallel to each other such that adjacent ends thereof are pivotally mounted inside the housing 11 and remaining portions of the two swing arms 21 are located in the receiving space 19. The other ends of the two swing arms 21 are respectively disposed on opposite sides of a movable ring 25. The movable ring 25 defines a second valve opening 251 and is movably mounted on the second flange 17 so as to move toward or away from the first plate 12. The first valve opening 121 and the second valve opening 251 face each other. The movable ring 25 is in an airtight engagement with the second flange 17. A portion of the movable ring 25 faces the first plate 12 and has a contacting surface 26. A sealing ring 261 is disposed on the contacting surface 26. A plurality of elastic members 27 are disposed between the movable ring 25 and the second flange 17. In the first embodiment, the plurality of elastic members 27 may be exemplified as springs that generate an elastic restoring force urging the movable ring 25 toward the first plate 12. In the first embodiment, the first valve opening 121 and the second valve opening 251 are circular.

The sliding valve plate 31 has a plate body 32 and two roller assemblies 34 respectively disposed on opposite sides of the plate body 32 and configured to move in unison with the plate body 32. Each of the two roller assemblies 34 comprises a plurality of plate rollers 341 configured to roll against the first plate 12 and comprises an arm roller 342. The arm rollers 342 are configured to roll against the respective swing arms 21. The arm roller 342 of each of the roller assemblies 34 is disposed between the first plate 12 and the two swing arms 21. In the first embodiment, the plate body 32 has an arc-shaped recess 321 formed inward from an edge thereof, and the arc-shaped recess 321 faces the first valve opening 121.

The actuator 41 is disposed on the first plate 12, connected to the sliding valve plate 31, and configured to drive the sliding valve plate 31 to move within the receiving space 19 so as to cause the two roller assemblies 34 to move relative to the two swing arms 21. In the first embodiment, the actuator 41 has a knob 42 and a linkage arm 44, and the plate body 32 has a driving slot 323. The linkage arm 44 has an outer end configured to carry a slider 441 so as to be received in the driving slot 323. The knob 42 is operable to drive the outer end of the linkage arm 44 in a circular motion, such that the slider 441 moves along the driving slot 323 and engages a wall of the driving slot 323 to drive movement of the plate body 32. The aforementioned technical features enable users to manually operate the knob 42 to actuate the plate body 32. However, the actuator 41 may alternatively be implemented as a pneumatic device, such as an air cylinder, or as an electric device, such as a motor in combination with a screw, as required. These alternatives are known in the art and therefore not illustrated by any accompanying diagrams.

Each of the two swing arms 21 has a pressing edge 211, a closing positioning groove 22 and an opening positioning groove 24 recessed from the pressing edge 211 such that the arm rollers 342 of the two roller assemblies 34 roll against or into the closing and opening positioning grooves 22 and 24. The closing positioning groove 22 is located between the opening positioning groove 24 and the movable ring 25. In the first embodiment, bottom surfaces of both the opening positioning groove 24 and the closing positioning groove 22 are arc-shaped. This configuration allows the arm rollers 342 to conform to the groove shape after rolling into the grooves. In addition to ensuring that the arm rollers 342 reach the maximum depth after rolling into the grooves, the arc-shaped surfaces also render it easy for the arm roller 342 to roll out of the grooves.

When the arm rollers 342 of the two roller assemblies 34 roll into the opening positioning groove 24, the plate body 32 is not positioned between the movable ring 25 and the first plate 12, and the plurality of elastic members 27 maintain the movable ring 25 pressed against the first flange 13 of the first plate 12 such that the sealing ring 261 engages the first flange 13 to provide sealing. At this time, the first valve opening 121 and the second valve opening 251 are in communication with each other to allow passage of gas, but gas or dust is prevented from entering the receiving space 19 due to the sealing engagement of the sealing ring 261.

When the arm rollers 342 of the two roller assemblies 34 roll against the pressing edge 211 without rolling into the opening positioning groove 24 or the closing positioning groove 22, the arm rollers 342 of the two roller assemblies 34 press against the two swing arms 21 to cause the two swing arms 21 to pivot, thereby forcing the movable ring 25 to move away from the first plate 12 against the elastic force of the plurality of elastic members 27 so as to form a spacing S between the movable ring 25 and the first plate 12, allowing the plate body 32 to enter.

When the arm rollers 342 of the two roller assemblies 34 roll into the closing positioning groove 22, the plate body 32 enters between the movable ring 25 and the first plate 12 and fully covers the first valve opening 121, and the plurality of elastic members 27 maintain the movable ring 25 pressed against the plate body 32 such that the sealing ring 261 engages the plate body 32 to provide sealing, thereby allowing the plate body 32 to block communication between the first valve opening 121 and the second valve opening 251 and preventing gas from passing therethrough or entering the receiving space 19 through the second valve opening 251 due to the sealing engagement of the sealing ring 261.

In the first embodiment, the first plate 12 and the second plate 16 together form two sidewalls 191 and therefore are located on opposite sides of the receiving space 19, and each of the roller assemblies 34 further comprises a plurality of side rollers 343 configured to roll against the two sidewalls 191. The aforementioned technical features facilitate stabilizing the sliding valve plate 31 within the receiving space 19 through the plurality of side rollers 343 of the two roller assemblies 34. However, the plurality of side rollers 343 may alternatively be omitted. For example, when the actuator 41 is implemented as a pneumatic cylinder or as a motor in combination with a screw (not shown), the actuator 41 inherently provides directional guidance during actuation, and thus roll-against guidance by the plurality of side rollers 343 is not required.

The structural features of the first embodiment are described above. The operation states of the first embodiment are described below.

FIG. 1 through FIG. 7 illustrate an open state. The arm rollers 342 of the two roller assemblies 34 are located within the opening positioning groove 24. The sealing ring 261 is configured to be pressed against the first flange 13 to provide a hermetic seal. The plate body 32 is located within the receiving space 19 without being positioned between the movable ring 25 and the first plate 12. At this time, the first valve opening 121 and the second valve opening 251 are in communication with each other to allow passage of gas (not shown), while preventing gas from entering the receiving space 19 as a result of a sealing engagement between the sealing ring 261 and the first flange 13. Therefore, the open state is conducive to dustproofing. The arc-shaped recess 321 of the plate body 32 does not interfere with the first flange 13, while allowing opposite lateral portions of the plate body 32 to be positioned closer to the first valve opening 121. As a result, the overall stroke required by the plate body 32 can be reduced, thereby reducing the overall length of the structure. However, the arc-shaped recess 321 may alternatively be omitted, depending on practical requirements.

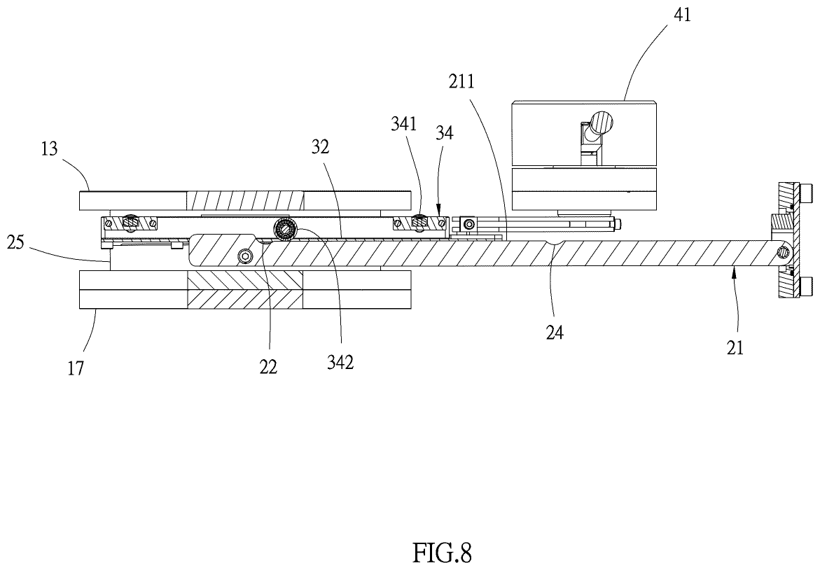

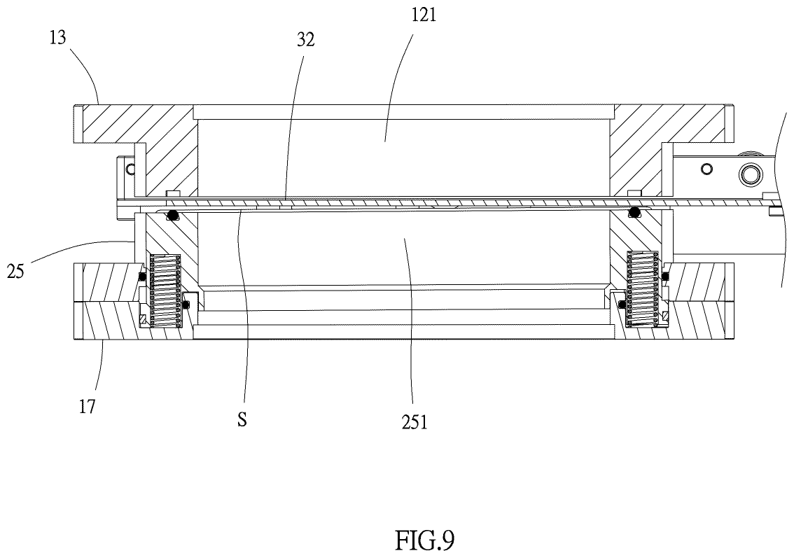

As shown in FIG. 8 through FIG. 9, the transition from the open state to a closed state is illustrated. At this time, the user operates the actuator 41 to drive the sliding valve plate 31 to move, causing the arm rollers 342 of the two roller assemblies 34 to roll out of the opening positioning groove 24 and to roll against the pressing edge 211, but not yet to enter the closing positioning groove 22. Accordingly, the two swing arms 21 are forced to swing, thereby driving the movable ring 25 to overcome the restoring elasticity of the plurality of elastic members 27 and to move away from the first flange 13. As a result, the spacing S is formed between the movable ring 25 and the first flange 13, such that the plate body 32 can enter the spacing S.

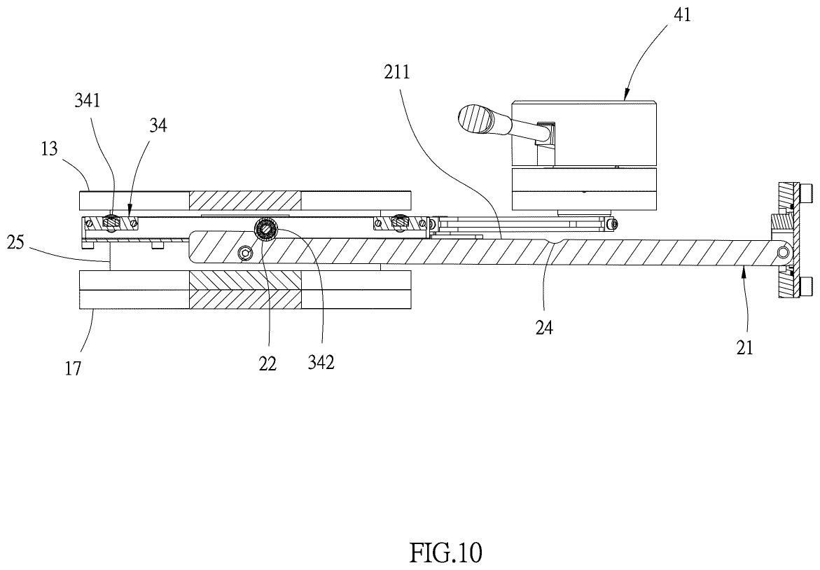

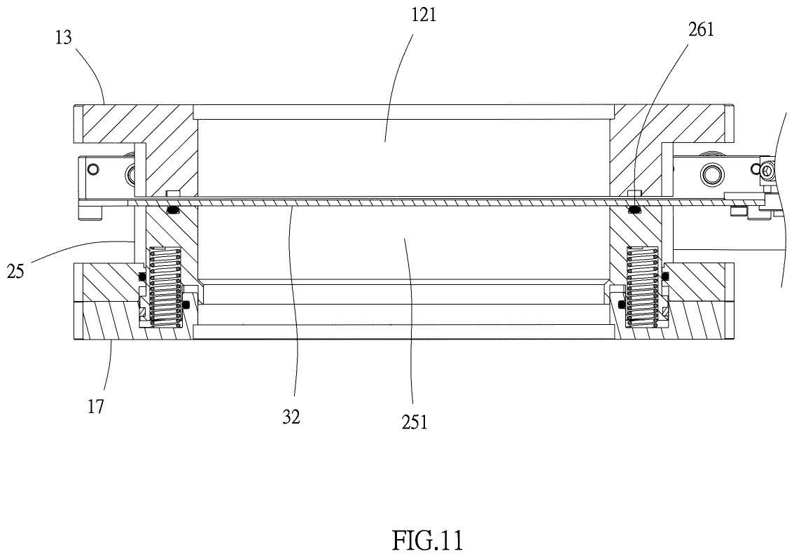

FIG. 10 through FIG. 11 illustrate the closed state. The arm rollers 342 of the two roller assemblies 34 are located within the closing positioning groove 22, but the plate body 32 enters between the movable ring 25 and the first flange 13 and fully covers the first valve opening 121, allowing the plurality of elastic members 27 to push the movable ring 25 to cause the sealing ring 261 to be pressed against the plate body 32, thereby closing the first valve opening 121. At this time, the first valve opening 121 and the second valve opening 251 are blocked by the plate body 32 and thus are not in communication, preventing gas from passing through. Similarly, due to the sealing engagement of the sealing ring 261, gas cannot enter the receiving space 19 through the second valve opening 251.

Switching from the closed state to the open state is achieved by performing the aforementioned operations in reverse.

In the aforementioned operations, the rolling interaction between the arm roller 342 of each of the two roller assemblies 34, and the opening positioning groove 24, the closing positioning groove 22, and the pressing edge 211 of each of the two swing arms 21 plays a key role. When the arm rollers 342 roll against the pressing edges 211, the two swing arms 21 are forced to swing downward (taking the direction shown in FIG. 9 as an example). However, when the arm rollers 342 are located within the opening positioning grooves 24 or closing positioning grooves 22, the groove depth prevents the two swing arms 21 from being pushed downward. Therefore, the plurality of elastic members 27 drive the movable ring 25 upward, causing the sealing ring 261 to engage the first flange 13 or the plate body 32, thereby establishing a hermetic seal.

Therefore, in the open state of the first embodiment, the sealing ring 261 engages the first flange 13 to establish a hermetic seal, effectively prevent dust ingress, eliminate the need for a dustproof tube and still maintain dustproof performance when a valve opening is in the open state, overcoming the aforementioned drawbacks of the prior art.

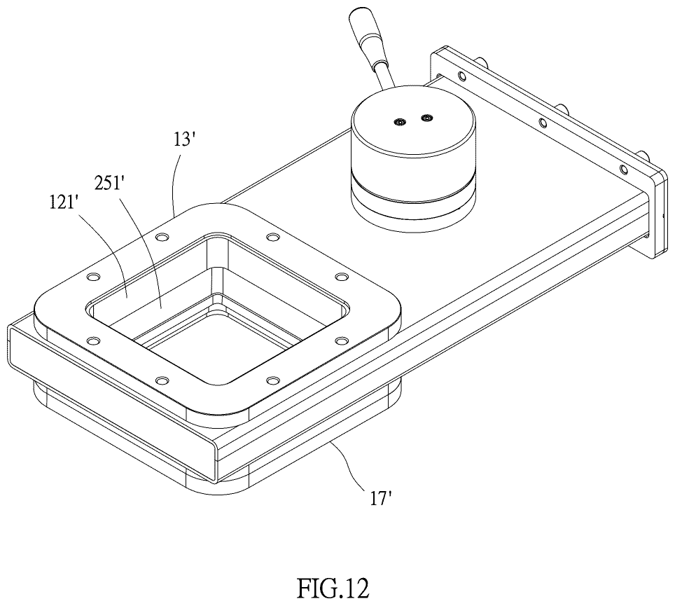

In the first embodiment, the first flange 13 and the second flange 17 are circular. However, they may alternatively be formed in other shapes as required. For example, as shown in FIG. 12, the first flange 13′ and the second flange 17′ are rectangular, such that the first valve opening 121′ and the second valve opening 251′ are also rectangular, allowing the movable ring (not shown) to be rectangular as well.

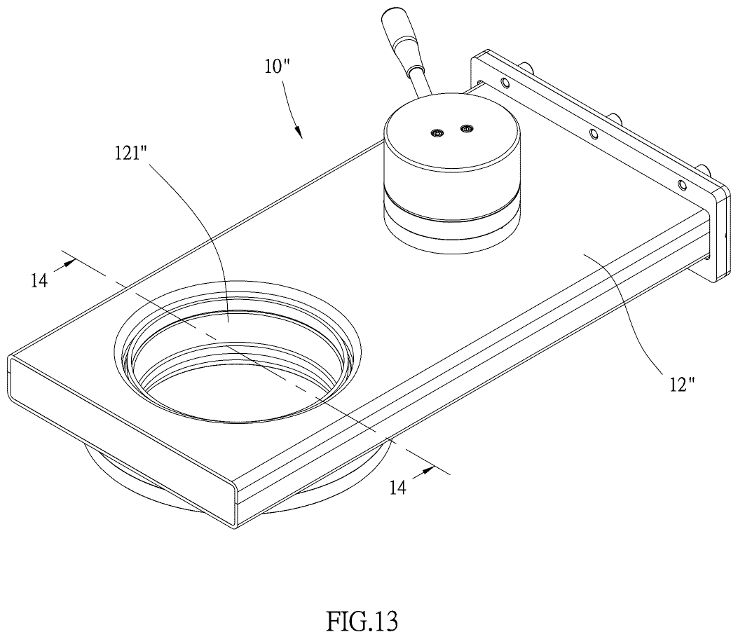

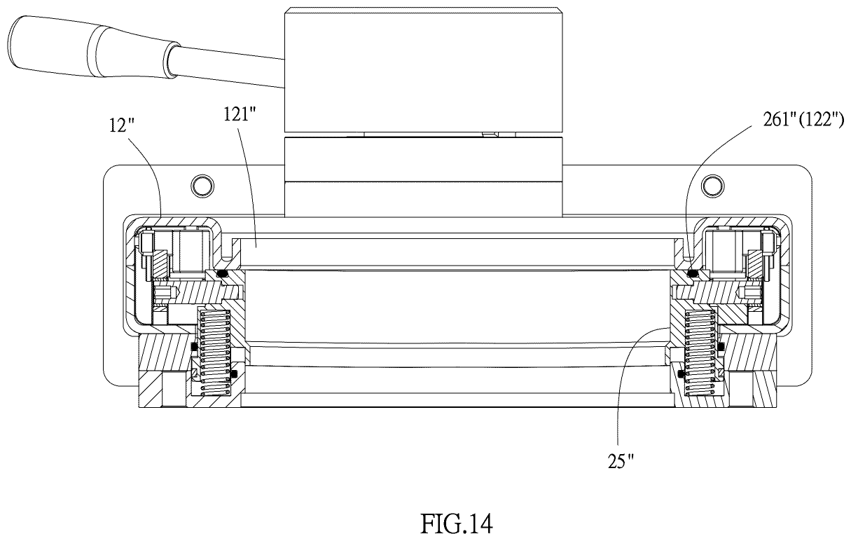

As shown in FIG. 13 and FIG. 14, a dustproof gate valve 10″ is illustrated in the second preferred embodiment of the disclosure and differs from the corresponding structure in the first embodiment by the following technical features:

In the second embodiment, the first plate 12″ does not include the first flange as in the first embodiment. Instead, the first plate 12″ in the second embodiment has the first valve opening 121″ directly and a docking surface 122″. When the movable ring 25″ is pressed against the first plate 12″, the sealing ring 261″ engages the docking surface 122″ to provide a hermetic seal, thereby achieving a dustproof function.

The first flange can be omitted in the second embodiment while maintaining dustproofing functionality in the open state.

The other structures and achievable effects of the second embodiment are substantially the same as those of the first embodiment and are not described in detail herein.

The disclosure is disclosed above by embodiments. However, persons skilled in the art should understand that the embodiments are illustrative of the disclosure only, but shall not be interpreted as restrictive of the scope of the claims of the disclosure. Please note that all simple variations and implementation equivalent to the embodiments shall be deemed to fall within the scope of the claims of the disclosure.

What is claimed is:

1. A dustproof gate valve, comprising:
a housing having a first plate and a second plate, the housing defining therein a receiving space disposed between the first plate and the second plate, the first plate having a first valve opening penetrating therethrough;
two swing arms disposed parallel to each other such that adjacent ends thereof are pivotally mounted inside the housing and remaining portions of the two swing arms are located in the receiving space, with other ends respectively disposed on opposite sides of a movable ring, the movable ring defining a second valve opening and being movably mounted on the second plate so as to move toward or away from the first plate, allowing the first valve opening and the second valve opening to face each other, the movable ring being in an airtight engagement with the second plate, wherein a portion of the movable ring faces the first plate and has a contacting surface on which a sealing ring is disposed, and a plurality of elastic members are disposed between the movable ring and the second plate such that the movable ring is urged toward the first plate by an elastic restoring force of the elastic members;
a sliding valve plate having a plate body and two roller assemblies respectively disposed on opposite sides of the plate body and configured to move in unison with the plate body, each of the two roller assemblies comprising a plurality of plate rollers configured to roll against the first plate and comprising an arm roller, the two arm rollers being configured to roll against the respective swing arms; and
an actuator disposed on one of the first plate and the second plate, connected to the sliding valve plate, and configured to drive the sliding valve plate to move within the receiving space so as to cause the roller assemblies to move relative to the swing arms,
wherein each of the swing arms has a pressing edge, a closing positioning groove and an opening positioning groove recessed from the pressing edge such that the arm rollers of the roller assemblies roll against or into the grooves, with the closing positioning groove located between the opening positioning groove and the movable ring,
wherein, when the arm rollers roll into the opening positioning groove, the plate body is not positioned between the movable ring and the first plate, and the plurality of elastic members maintain the movable ring pressed against the first plate such that the sealing ring engages the first plate to provide sealing, thereby allowing the first valve opening and the second valve opening to communicate with each other to allow passage of gas, while preventing gas from entering the receiving space through the sealing engagement of the sealing ring,
wherein, when the arm rollers roll against the pressing edge without rolling into the opening positioning groove or the closing positioning groove, the arm rollers press against the two swing arms to cause the swing arms to pivot, thereby forcing the movable ring to move away from the first plate against the elastic force of the plurality of elastic members so as to form a spacing between the movable ring and the first plate, allowing the plate body to enter,
wherein, when the arm rollers roll into the closing positioning groove, the plate body enters between the movable ring and the first plate and fully covers the first valve opening, and the plurality of elastic members maintain the movable ring pressed against the plate body such that the sealing ring engages the plate body to provide sealing, thereby allowing the plate body to block communication between the first valve opening and the second valve opening and preventing gas from passing therethrough or entering the receiving space via the second valve opening through the sealing engagement of the sealing ring.

2. The dustproof gate valve of claim 1, wherein the actuator comprises a knob and a linkage arm, the plate body having a driving slot, the linkage arm having an outer end configured to carry a slider so as to be received in the driving slot, the knob being operable to drive the outer end of the linkage arm in a circular motion, such that the slider moves along the driving slot and engages a wall of the driving slot to drive movement of the plate body.

3. The dustproof gate valve of claim 1, wherein the first valve opening and the second valve opening are circular, the plate body has an arc-shaped recess formed inward from an edge thereof, and the arc-shaped recess faces the first valve opening.

4. The dustproof gate valve of claim 1, wherein the first valve opening and the second valve opening are rectangular.

5. The dustproof gate valve of claim 1, wherein the first plate has a first flange, the first valve opening being formed in the first flange, and when the arm rollers roll into the opening positioning groove, the plurality of elastic members maintain the movable ring pressed against the first flange with the sealing ring providing sealing.

6. The dustproof gate valve of claim 1, wherein the second plate has a second flange, the movable ring is movably mounted on the second flange, and the movable ring maintains an airtight engagement with the second flange.

7. The dustproof gate valve of claim 1, wherein the first plate and the second plate together form two sidewalls and therefore are located on opposite sides of the receiving space, and each of the roller assemblies further comprises a plurality of side rollers configured to roll against the two sidewalls.

8. The dustproof gate valve of claim 1, wherein bottom surfaces of both the opening positioning groove and the closing positioning groove are arc-shaped.
